(19) United States
(12) Patent Application Publication
(10) Pub. No.: US 2026/0338936 A1
(43) Pub. Date: Oct. 29, 2026

(54) MULTISTATIC RADAR SYSTEM, VEHICLE, AND METHOD FOR SYNCHRONIZING A PLURALITY OF RADARS

(71) Applicant: Murata Manufacturing Co., Ltd., Nagaokakyo-shi (JP)

(72) Inventor: Katsuhisa KASHIWAGI, Nagaokakyo-shi (JP)

(73) Assignee: Murata Manufacturing Co., Ltd., Nagaokakyo-shi (JP)

(21) Appl. No.: 19/711,186

(22) Filed: Jun. 17, 2026

Related U.S. Application Data
(63) Continuation-in-part of application No. PCT/JP2024/032451, filed on Sep. 10, 2024.

(30) Foreign Application Priority Data
Dec. 22, 2023 (JP) 2023-217219
Aug. 8, 2025 (JP) 2025-133916

(51) Int. Cl. G01S 13/00; G01S 7/35; G01S 13/42; G01S 13/931

(52) U.S. Cl. CPC G01S 13/003; G01S 7/352; G01S 13/42; G01S 13/931

(57) ABSTRACT

Provided are a multistatic radar system, a vehicle, and a method for synchronizing a plurality of radars. A multistatic radar system includes at least two radars. including a first radar configured to operate on a cycle of a first synchronization signal, transmit a transmission wave, and acquire a first intermediate frequency (IF) signal based on the transmission wave and a first reflected wave of the transmission wave from a target; a second radar configured to operate on a cycle of a second synchronization signal, receive a second reflected wave of the transmission wave from the target, and acquire a second IF signal based on the second reflected wave. The multistatic radar system includes processing circuitry configured to compensate for desynchronization between the first synchronization signal and the second synchronization signal.

### CROSS-REFERENCE TO RELATED APPLICATIONS

This application is a continuation-in-part of International Patent Application No. PCT/JP2024/032451, filed on Sep. 10, 2024, which claims the benefit of priority from Japanese Patent Application No. 2023-217219 filed on Dec. 22, 2023, and Japanese Patent Application No. 2025-133916 filed on Aug. 8, 2025, the entire contents of each are incorporated herein by reference.

### BACKGROUND

### 1. Technical Field

The present disclosure relates to a multistatic radar system, a vehicle including the same, and a method for synchronizing a plurality of radars.

### 2. Description of the Related Art

Conventionally, technologies have been disclosed that use a plurality of radio detection and ranging (radars) to estimate a distance and direction to a target with high accuracy (for example, A. Correas-Serrano et al., “Performance Analysis and Design of a Distributed Radar Network for Automotive Application,”, doi: 10.23919/IRS54158.2022.9904987 and M. Gottinger et al., “Coherent Signal Processing for Loosely Coupled Bistatic Radar,”, doi: 10.1109/TAES.2021.3050650). In a radar system including a plurality of radars, synchronization of transmission and reception timing among the radars is needed.

### SUMMARY

A multistatic radar system according to an aspect of the present disclosure includes at least two radars. The multistatic radar system includes: a first radar configured to operate on a cycle of a first synchronization signal, transmit a transmission wave, and acquire a first intermediate frequency (IF) signal based on the transmission wave and a first reflected wave of the transmission wave from a target; a second radar configured to operate on a cycle of a second synchronization signal, receive a second reflected wave of the transmission wave from the target, and acquire a second IF signal based on the second reflected wave; and a synchronization compensator configured to reduce desynchronization between the first synchronization signal and the second synchronization signal.

With this configuration, desynchronization between the first synchronization signal to be given to the first radar and the second synchronization signal to be given to the second radar is reduced. With this configuration, position estimation accuracy in the subsequent processor can be improved.

The present disclosure can achieve a multistatic radar system and a method for synchronizing a plurality of radars that can improve position estimation accuracy.

### BRIEF DESCRIPTION OF THE DRAWINGS

FIG. 1 is a block diagram of a schematic configuration of a multistatic radar system according to an embodiment;

FIG. 2 is a timing chart for the multistatic radar system;

FIG. 3 is a block diagram of a configuration example of a controller according to a comparative example;

FIG. 4 is a conceptual diagram of the delay of a synchronization signal in the comparative example;

FIG. 5 is a block diagram of an example of the configuration of a synchronization signal controller of the multistatic radar system according to the embodiment;

FIG. 6 is a flowchart of an example of distance estimation processing using an AF method;

FIG. 7 is a diagram of time-series data up to a sampling point N;

FIG. 8 is a diagram of an example of the results of the distance estimation by the AF method;

FIG. 9 is a graph illustrating specific examples of lookup tables;

FIG. 10 is a conceptual diagram of a correction example of a synchronization signal in the embodiment; and

FIG. 11 is a block diagram of an example of an additional configuration of a controller according to a modification of the embodiment.

### DETAILED DESCRIPTION

As described above, in the multistatic radar system including a plurality of radars, synchronization of the transmission and reception timing among the radars is needed. However, the inventors have recognized that, due to differences in the length of signal propagation paths, such as coaxial cables, wiring on boards, and wiring in ICs, skew may occur, and thereby a discrepancy may also occur in the transmission and reception timing, which may reduce position estimation accuracy.

For the foregoing reasons, there is a need for a multistatic radar system that can improve the position estimation accuracy, a vehicle including the same, and a method for synchronizing a plurality of radars.

The following describes a multistatic radar system and a method for synchronizing a plurality of radars according to an embodiment in detail based on the accompanying drawings. The present disclosure is not limited by this embodiment. For example, in the following description, for the sake of simplicity, a case in which the multistatic radar system is a bistatic radar system including two radars will be described as an example, but the multistatic radar system may include three or more radars.

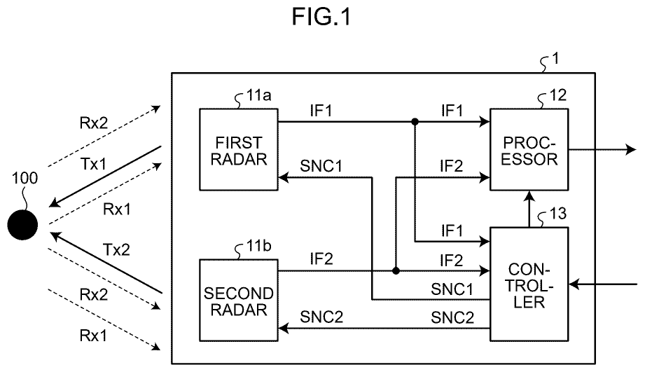

FIG. 1 is a block diagram of a schematic configuration of the multistatic radar system according to the embodiment. This multistatic radar system 1 according to the embodiment includes a first radar 11a, a second radar 11b, a processor 12, and a controller 13.

In the configuration of the multistatic radar system 1 according to the embodiment, the first radar 11a and the second radar 11b each include, for example, a plurality of transmission antennas and reception antennas, and are frequency modulated continuous wave (FMCW) type or fast chirp modulation (FCM) type radars capable of acquiring the distance information and angle information of an observation target. Since the FMCW type and FCM type radars are well known, detailed descriptions may be omitted. The present disclosure is broadly applicable to sensors capable of estimating a distance and an angle based on the time difference between a transmission signal and a reception signal using electromagnetic waves (including light) or sound waves.

The first radar 11a is configured to emit a transmission wave Tx1 toward a target 100, receive a reflected wave Rx1 of the transmission wave Tx1 from the target 100 and a reflected wave Rx2 of a transmission wave Tx2, which will be described later, from the target 100, and acquire a first intermediate frequency (IF) signal IF1. Alternatively, the first radar 11a is configured to emit the transmission wave Tx1 toward the target 100, receive the reflected wave Rx1 of the transmission wave Tx1 from the target 100 or the reflected wave Rx2 of the transmission wave Tx2, which will be described later, from the target 100, and acquire the first IF signal IF1.

The second radar 11b is configured to emit a transmission wave Tx2 toward the target 100, receive the reflected wave Rx2 of the transmission wave Tx2 from the target 100 and the reflected wave Rx1 of the transmission wave Tx1 from the target 100, and acquire a second IF signal IF2. Alternatively, the second radar 11b is configured to emit the transmission wave Tx2 toward the target 100, receive the reflected wave Rx2 of the transmission wave Tx2 from the target 100 or the reflected wave Rx1 of the transmission wave Tx1 from the target 100, and acquire the second IF signal IF2.

In the following description, the reflected wave Rx1 and the reflected wave Rx2 may be collectively represented as a reflected wave Rx. Similarly, the transmission wave Tx1 and the transmission wave Tx2 may be collectively represented as a transmission wave Tx.

The processor 12 estimates and outputs a distance and angle to the target 100, based on the first IF signal IF1 acquired by the first radar 11a and the second IF signal IF2 acquired by the second radar 11b. The present disclosure is not limited by the details of the specific processing of the processor 12.

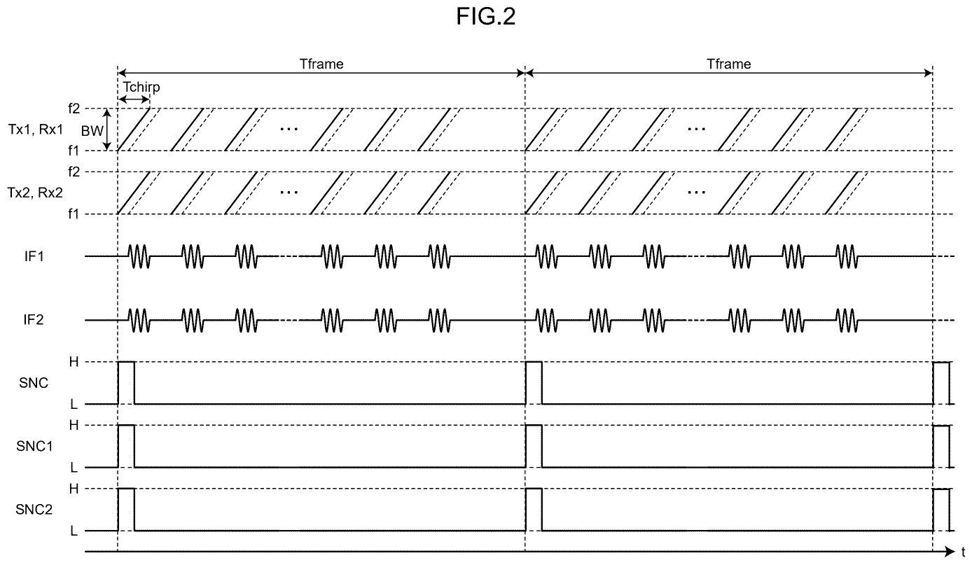

The controller 13 is a component that controls the first radar 11a, the second radar 11b, and the processor 12 based on control commands from the outside. Before describing the configuration and operation of the controller 13 according to the embodiment, the basic operation of the multistatic radar system of the present disclosure will be described. FIG. 2 is a timing chart for the multistatic radar system. FIG. 2 illustrates signals when the first radar 11a and the second radar 11b are FMCW type radars.

The first radar 11a generates the transmission wave Tx1 based on a first synchronization signal SNC1 supplied from the controller 13. Specifically, the first radar 11a transmits a chirp signal a predetermined number of times within a Tframe-cycle of the first synchronization signal SNC1, wherein the chirp signal is a signal in which the frequency is linearly modulated over a bandwidth BW ranging from a frequency f1 to a frequency f2 on a cycle of Tchirp. FIG. 2 illustrates the transmission wave Tx1 with a solid line.

The first radar 11a receives the reflected wave Rx1 and the reflected wave Rx2 reflected by the target 100. Alternatively, the first radar 11a receives the reflected wave Rx1 or the reflected wave Rx2 reflected by the target 100. FIG. 2 illustrates each of the reflected waves Rx with a broken line. The first radar 11a then generates the first IF signal IF1 by combining the transmission wave Tx1 and the reflected wave Rx.

The second radar 11b generates the transmission wave Tx2 based on a second synchronization signal SNC2 supplied from the controller 13. Specifically, the second radar 11b transmits a chirp signal a predetermined number of times within a Tframe-cycle of the second synchronization signal SNC2, wherein the chirp signal is a signal in which the frequency is linearly modulated over the bandwidth BW ranging from the frequency f1 to the frequency f2 on a cycle of Tchirp. FIG. 2 illustrates the transmission wave Tx2 with a solid line.

The second radar 11b receives the reflected wave Rx1 and the reflected wave Rx2 reflected by the target 100. Alternatively, the second radar 11b receives the reflected wave Rx1 or the reflected wave Rx2 reflected by the target 100. FIG. 2 illustrates each of the reflected waves Rx with a broken line. The second radar 11b then generates the second IF signal IF2 by combining the transmission wave Tx2 and the reflected wave Rx.

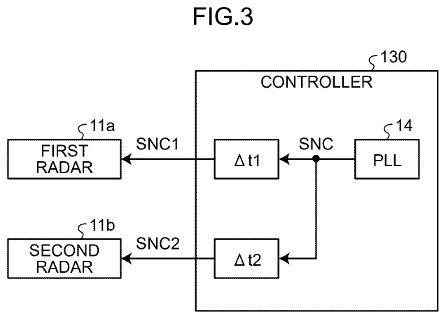

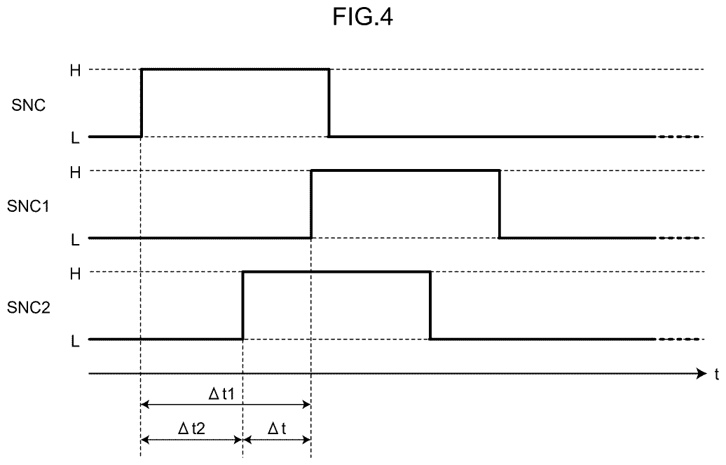

FIG. 3 is a block diagram of a configuration example of a controller according to a comparative example. FIG. 4 is a conceptual diagram of the delay of a synchronization signal in the comparative example.

In the configuration according to the comparative example, this controller 130 includes a synchronization signal generator 14. The synchronization signal generator 14 generates a synchronization signal SNC.

The synchronization signal SNC generated by the synchronization signal generator 14 experiences delay due to signal propagation paths such as coaxial cables, wiring on a board, and wiring inside an IC. Specifically, the synchronization signal SNC arrives at the first radar 11a as the first synchronization signal SNC1 delayed by a delay time Δt1. The synchronization signal SNC arrives at the second radar 11b as the second synchronization signal SNC2 delayed by a delay time Δt2. As a result of this, as illustrated in FIG. 4, a delay time difference Δt (=Δt1−Δt2) arises between the first synchronization signal SNC1 and the second synchronization signal SNC2, which causes desynchronization between the first synchronization signal SNC1 to be given to the first radar 11a and the second synchronization signal SNC2 to be given to the second radar 11b, reducing position estimation accuracy in the subsequent processor 12.

The following describes the configuration and the method for synchronizing of the present embodiment that can improve position estimation accuracy in a multistatic radar system including a plurality of radars.

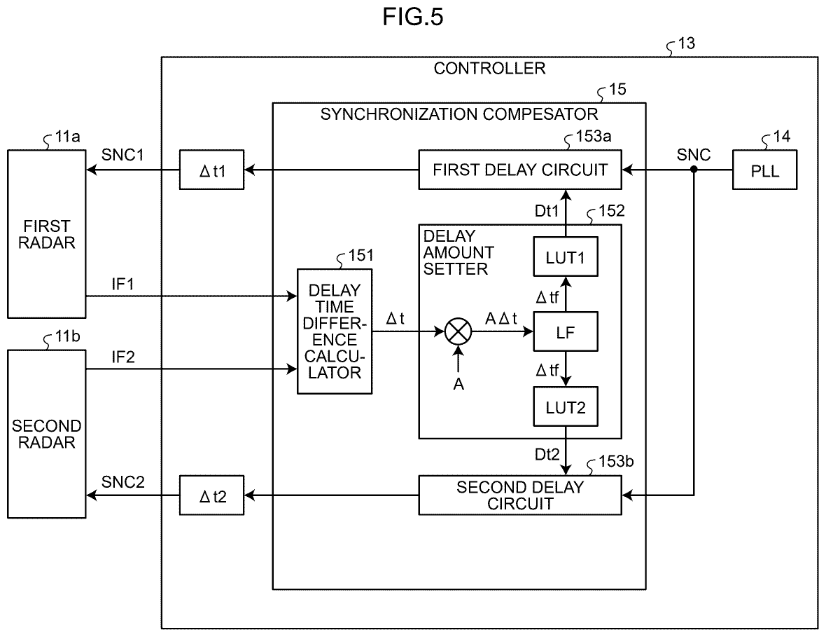

FIG. 5 is a block diagram of an example of the configuration of a synchronization signal controller of the multistatic radar system according to the embodiment. In the configuration according to the embodiment, the controller 13 includes a synchronization compensator 15 in addition to the synchronization signal generator 14.

The synchronization compensator 15 includes a delay time difference calculator 151, a delay amount setter 152, a first delay circuit 153a, and a second delay circuit 153b. The functionality of the elements disclosed herein (including the controller 13, processor 12, synchronization compensator 15, delay time difference calculator 151, and delay amount setter 152) may be implemented using circuitry or processing circuitry which includes general purpose processors, special purpose processors, integrated circuits, ASICs (“Application Specific Integrated Circuits”), FPGAs (“Field Programmable Gate Arrays”), conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. There is a memory that stores a computer program which includes computer instructions that provide the logic and routines that enable the hardware circuitry to perform the synchronization and filtering methods disclosed herein.

The delay time difference calculator 151 calculates the delay time difference Δt between the first IF signal IF1 and the second IF signal IF2. The delay time difference Δt between the first IF signal IF1 and the second IF signal IF2 is expressed by Expression (1) below. In Expression (1) below, Fif1 represents the frequency of the reflected wave Rx1 contained in the first IF signal IF1 when the transmission wave Tx1 is transmitted, and Fif2 represents the frequency of the reflected wave Rx1 contained in the second IF signal IF2 when the transmission wave Tx1 is transmitted.

In the synchronization measurement mode, both the first radar 11a and the second radar 11b receive the reflected wave Rx1 of the transmission wave Tx1. During this mode, the first radar 11a generates the first IF signal IF1 by mixing the transmission wave Tx1 with the received reflected wave Rx1, both referenced to the first synchronization signal SNC1. Accordingly, the frequency Fif1 of the first IF signal IF1 reflects the round-trip propagation time from the first radar 11a to the target 100 and back, and is independent of any timing offset between SNC1 and SNC2. The second radar 11b, however, generates the second IF signal IF2 during this mode by mixing the transmission wave Tx1, whose chirp timing is governed by the first synchronization signal SNC1, with the reflected wave Rx1 received through a reception sampling window governed by the second synchronization signal SNC2. Because the chirp reference (SNC1) and the reception reference (SNC2) are independent and differ by the delay time difference Δt, the frequency Fif2 of the second IF signal IF2 is shifted relative to Fif1 by an amount proportional to Δt and to the chirp slope (BW/Tchirp). This frequency shift is expressed by Expression (1) below, which allows the delay time difference calculator 151 to determine Δt from the measurable frequency difference Fif1−Fif2 without requiring a dedicated signal path between the two radars.

$$Δ t = Δ t 1 - Δ t 2 = ( \frac{Tchirp}{Bw} ) ( Fif 1 - Fif 2 ) \qquad ( 1 )$$

The frequency Fif1 is the frequency determined from the spectrum after the first IF signal IF1 is subjected to Range-FFT processing. The frequency Fif2 is the frequency determined from the spectrum after the second IF signal IF2 is subjected to Range-FFT processing. The Range-FFT processing may be executed by the first radar 11a and the second radar 11b or executed by the synchronization compensator 15.

In addition, the processing for deriving the frequency Fif1 and the frequency Fif2 is not limited to the FFT processing, and may be, for example, processing using an annihilating filter (AF) method (hereinafter also referred to as “AF method”). By using the AF method, the processing speed can be significantly improved (for example, by about 25 times) compared to a mode in which the FFT processing is executed on a cycle of Tframe.

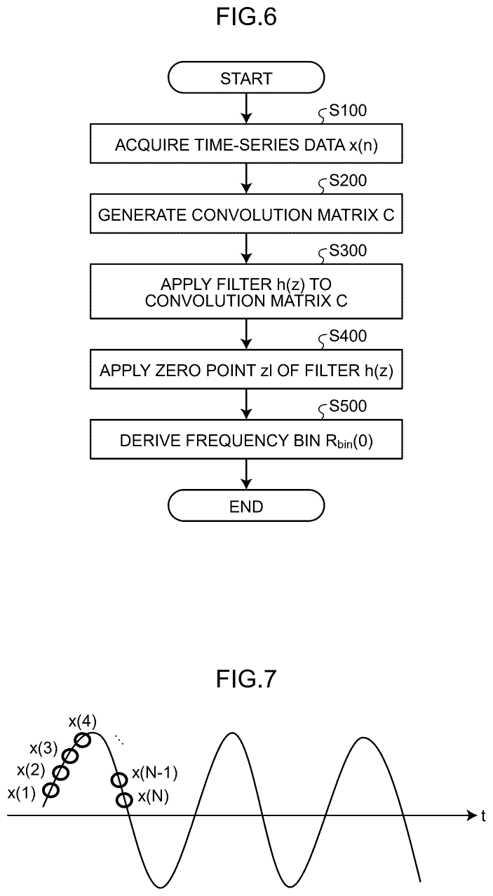

The following describes a specific example of acceleration of distance estimation processing using the AF method. FIG. 6 is a flowchart of an example of the distance estimation processing using the AF method.

First, data x(n) (where n is a natural number from 1 to N, and N is a data length) is acquired in a time-series manner (at each sampling point) (Step S100), and a convolution matrix C represented by Expression (2) below is generated (Step S200). The data x(n) represents the time-series data of the IF signal acquired by the radar. FIG. 7 is a diagram of the time-series data up to a sampling point N. In Expression (2) below, L represents an estimated number of spectra.

$$C = [ \begin{matrix}{x}_{L + 1} & {x}_{L} & … & {x}_{2} & {x}_{1} \\ {x}_{L + 2} & {x}_{L + 1} & … & {x}_{3} & {x}_{2} \\ ⋮ & ⋮ & ⋱ & ⋮ & ⋮ \\ {x}_{N} & {x}_{N - 1} & … & {x}_{N - L - 1} & {x}_{N - L}\end{matrix} ] \qquad ( 2 )$$

Next, a filter h(z) used in the AF method is generated with the convolution matrix C represented by Expression (2) above (Step S300). A filter coefficient H of h(z) is determined by a minimization problem represented by Expression (3) below. The optimization problem used in this embodiment is an example, and other methods may also be used.

minimize∥CH^{T}∥₂H=[h₀,h₁, . . . ,h_{L}] (3)

Next, using Expression (4) below, a zero point z₁ of the filter h(z) composed of the filter coefficient H is applied (Step S400). Here, L is the estimated number of spectra.

$$h ( z ) = {h}_{0} {z}^{L} + {h}_{1} {z}^{L - 1} + … + {h}_{L} = {h}_{0} {\prod }_{l = 1}^{L} ( z - {z}_{l} ) = 0 \qquad ( 4 )$$

Then, using Expression (5) below, a corresponding frequency bin is determined from the zero point z₁. While the FFT processing represents frequency bins using integers, the AF method estimates real-valued frequencies. Since the estimated number of spectra is L in this example, L line spectra are output. For simplicity, assuming that the amplitude is maximum when 1=0, r_{bin}(0) is regarded as an output bin (Step S500).

$${r}_{bin} ( l ) = \frac{{Tan}^{- 1} ( \frac{lm ( {z}_{l} )}{Re ( {z}_{l} )} )}{2 π} N \qquad ( 5 )$$

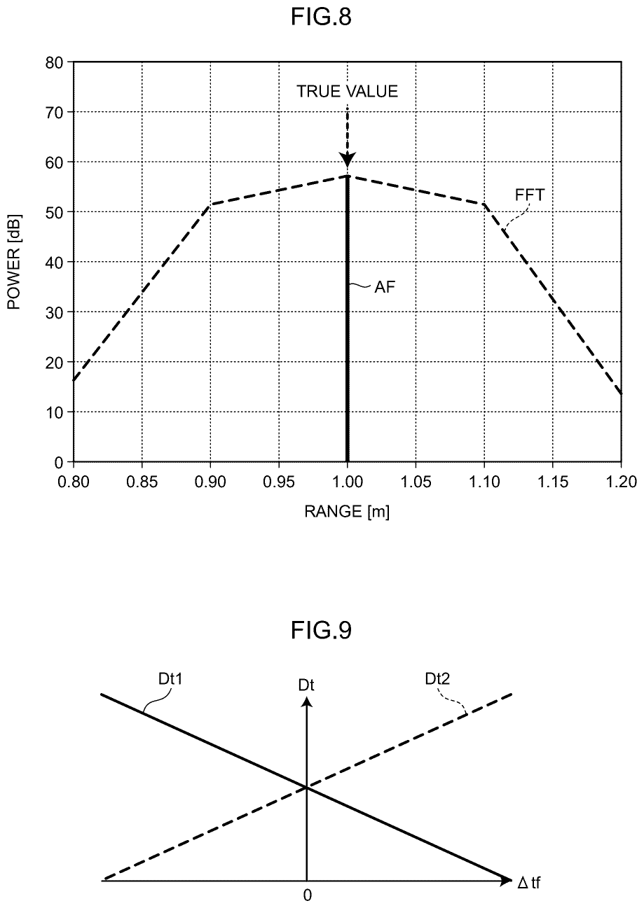

FIG. 8 is a diagram of an example of the results of the distance estimation by the AF method. In FIG. 8, the distance (Range) is exemplified as the horizontal axis, and the distance (Range) is obtained by multiplying r_{bin}(0), which is the calculation result of Expression (5) above, by a distance resolution represented by a predetermined constant. As the horizontal axis of FIG. 8 illustrating the estimation result by the AF method, r_{bin}(0), which is the calculation result of Expression (5) above, may be used.

The delay amount setter 152 executes loop filter (LF) processing to derive a delay amount Δtf.

In FIG. 5, “A” represents a loop gain in the loop filter (LF) processing. The delay amount setter 152 multiplies the delay time difference Δt, which is calculated by the delay time difference calculator 151, by the predetermined loop gain A. By scaling the delay time difference Δt by the loop gain A prior to the loop filter processing, the feedback loop is stabilized and the convergence rate of the synchronization correction is controlled. Thus, it is possible to achieve stabilization of a feedback loop and a reduction in errors.

The delay amount Δtf is expressed by Expression (6) below. In Expression (6) below, LF represents a filter function in discrete time; if there is a phase margin in the feedback loop, it may be, for example, a simple low pass filter (LPF) by finite impulse response (FIR) or the like. As a result of this, the delay amount Δtf after the loop filter (LF) processing becomes a discrete value with a high-frequency component smoothed.

Δt_{f}=LF(AΔt) (6)

The delay amount setter 152 uses a first lookup table LUT1 to derive a first delay amount Dt1 corresponding to the delay amount Δtf after the loop filter (LF) processing. The delay amount setter 152 uses a second lookup table LUT2 to derive a second delay amount Dt2 corresponding to the delay amount Δtf after the loop filter (LF) processing. FIG. 9 is a graph illustrating specific examples of lookup tables. The solid line illustrated in FIG. 9 represents the first delay amount Dt1 obtained by the first lookup table LUT1. The broken line illustrated in FIG. 9 represents the second delay amount Dt2 obtained by the second lookup table LUT2.

Each of the first delay amount Dt1 and the second delay amount Dt2 may be a value representing analog real time or a discrete value used in digital processing. When each of the first delay amount Dt1 and the second delay amount Dt2 is real time, the relation thereof with the delay time difference Δt is expressed by Expression (7) below.

Δt=−(Dt1−Dt2) (7)

The first delay circuit 153a applies the first delay amount Dt1 to the synchronization signal SNC to generate the first synchronization signal SNC1.

Specifically, the first delay circuit 153a delays the first synchronization signal SNC1 according to the first delay amount Dt1. As a result of this, the delay time of the first synchronization signal SNC1 with respect to the synchronization signal SNC is a value obtained by adding the delay time Δt1 and the real time corresponding to the first delay amount Dt1.

The second delay circuit 153b applies the second delay amount Dt2 to the synchronization signal SNC to generate the second synchronization signal SNC2. Specifically, the second delay circuit 153b delays the second synchronization signal SNC2 according to the second delay amount Dt2. As a result of this, the delay time of the second synchronization signal SNC2 with respect to the synchronization signal SNC is a value obtained by adding the delay time Δt2 and the real time corresponding to the second delay amount Dt2.

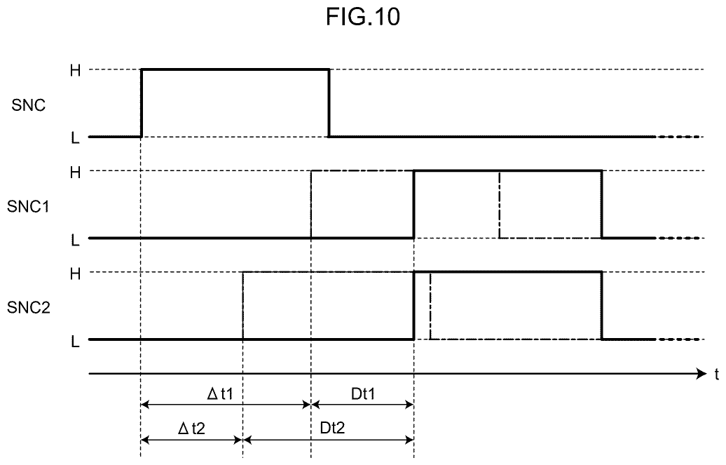

FIG. 10 is a conceptual diagram of a correction example of a synchronization signal in the embodiment. The dash-dotted lines illustrated in FIG. 10 represent the first synchronization signal SNC1 and the second synchronization signal SNC2 of the comparative example illustrated in FIG. 4. When the first delay amount Dt1 and the second delay amount Dt2 are real times, the relation between the delay time of the first synchronization signal SNC1 with respect to the synchronization signal SNC and the delay time of the second synchronization signal SNC2 with respect to the synchronization signal SNC can be expressed by Expression (8) below.

Δt1+Dt1=Δt2+Dt2 (8)

As a result of this, the time delay difference between the first synchronization signal SNC1 and the second synchronization signal SNC2 is reduced.

Consequently, desynchronization between the first synchronization signal SNC1 to be given to the first radar 11a and the second synchronization signal SNC2 to be given to the second radar 11b is reduced. Therefore, position estimation accuracy in the subsequent processor 12 can be improved.

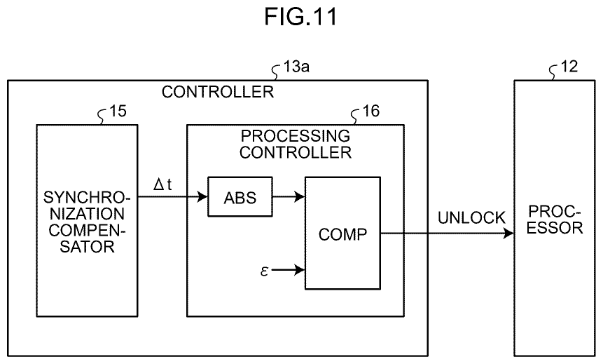

FIG. 11 is a block diagram of an example of an additional configuration of a controller according to a modification of the embodiment. In the example illustrated in FIG. 11, processing in the subsequent processor 12 is stopped (UNLOCK=1) according to the delay time difference Δt calculated by the delay time difference calculator 151 of the synchronization compensator 15.

Specifically, when the absolute value |Δt| of the delay time difference Δt calculated by the delay time difference calculator 151 of the synchronization compensator 15 exceeds a predetermined value ε, the processing controller 16 stops (UNLOCK=1) the processing in the subsequent processor 12, including distance and angle estimation based on the first IF signal IF1 and the second IF signal IF2. While the UNLOCK signal is asserted, the subsequent processor 12 withholds position estimation output, thereby preventing data of low reliability from being passed downstream. The predetermined value ε is a value determined by a maximum target distance error allowable in the multistatic radar system 1 of the present disclosure, and is a parameter that can be changed as desired. This predetermined value ε is expressed by Expression (9) below, where, for example, the maximum target distance error is AR and the speed of light is C.

ε=ΔR/C (9)

As a result of this, data output with low reliability can be reduced. In addition, power consumption can be reduced by eliminating position estimation in the subsequent processor 12.

The above embodiment is to facilitate understanding of the present disclosure and is not to interpret the present disclosure in a limited manner. The present disclosure can be modified or improved without departing from the gist thereof, and the present disclosure also includes equivalents thereof.

In multistatic radar systems, the following schemes are known: a scheme in which transmission and reception are performed simultaneously and division using frequency or the like is executed; and a scheme based on time division in which the radars performs transmission sequentially, with only one radar performing transmission at a time. These schemes, however, differ only in the dimension of multiplexing. Therefore, even when a received signal is the result of simultaneously receiving reflected waves of transmission waves from a plurality of radars, the signal is easily separated into signals each of which is a signal transmitted from one radar and received by a plurality of radars, by utilizing orthogonality between transmission signals in multiplexed dimensions. The synchronization method of the present disclosure is applicable regardless of the multiplexing scheme used.

For example, in the above embodiment, the transmission waves Tx are transmitted from both the first radar 11a and the second radar 11b, and these are mutually received as the reflected waves Rx by the first radar 11a and the second radar 11b. In other words, the first IF signal IF1 acquired by the first radar 11a and the second IF signal IF2 acquired by the second radar 11b can contain the reflected wave Rx1 of the transmission wave Tx1 and the reflected wave Rx2 of the transmission wave Tx2. However, for example, either the first radar 11a or the second radar 11b may transmit a transmission wave. In other words, the first IF signal IF1 and the second IF signal IF2 may contain either the reflected wave Rx1 of the transmission wave Tx1 or the reflected wave Rx2 of the transmission wave Tx2.

The above embodiment can be suitably used as an in-vehicle radar system. In this case, the first radar 11a and the second radar 11b may be provided at the front of a vehicle and used in order to detect the target 100 (for example, an obstacle or a human) located in front of the vehicle. The radars may be positioned at multiple locations on the vehicle body (front, rear, sides) and are not limited to the front-facing configuration.

The present disclosure can have the following configurations as described above or instead of the above.
(1) A multistatic radar system, which includes at least two radars, includes a first radar configured to operate on a cycle of a first synchronization signal, transmit a transmission wave to acquire a first IF signal from the transmission wave and a first reflected wave of the transmission wave from a target, a second radar configured to operate on a cycle of a second synchronization signal, receive a second reflected wave of the transmission wave from the target, and acquire a second IF signal based on the second reflected wave, and a synchronization compensator configured to reduce desynchronization between the first synchronization signal and the second synchronization signal.

With this configuration, desynchronization between the first synchronization signal to be given to the first radar and the second synchronization signal to be given to the second radar is reduced. With this configuration, position estimation accuracy in the subsequent processor can be improved.
(2) In the multistatic radar system according to (1) above, the synchronization compensator includes a delay time difference calculator configured to calculate a delay time difference between the first synchronization signal and the second synchronization signal based on a difference value between a frequency of the first IF signal and a frequency of the second IF signal, a delay amount setter configured to set a first delay amount and a second delay amount corresponding to the delay time difference, a first delay circuit configured to delay the first synchronization signal according to the first delay amount, and a second delay circuit configured to delay the second synchronization signal according to the second delay amount.
(3) In the multistatic radar system according to (2) above, the delay amount setter includes a loop filter configured to smooth a high-frequency component of a value obtained by multiplying the delay time difference by a predetermined gain, a first lookup table in which the first delay amount corresponding to an output of the loop filter is set, and a second lookup table in which the second delay amount corresponding to the output of the loop filter is set.
(4) In the multistatic radar system according to (2) or (3) above, the multistatic radar system further includes a processor that estimates a distance and angle to a target based on the first IF signal and the second IF signal.
(5) In the multistatic radar system according to (4) above, the multistatic radar system further includes a processing controller configured to stop processing in the processor when the delay time difference exceeds a predetermined value.

This configuration can reduce data output with low reliability. In addition, power consumption can be reduced by eliminating position estimation in the subsequent processor.
(6) A method for synchronizing a plurality of radars in a multistatic radar system including at least a first radar configured to operate on a cycle of a first synchronization signal, transmit a transmission wave, and acquire a first IF signal based on the transmission wave and a first reflected wave of the transmission wave from a target, and a second radar configured to operate on a cycle of a second synchronization signal, receive a second reflected wave of the transmission wave from the target, and acquire a second IF signal based on the second reflected wave, the method including: calculating a delay time difference between the first synchronization signal and the second synchronization signal based on a difference value between a frequency of the first IF signal and a frequency of the second IF signal; setting a first delay amount and a second delay amount corresponding to the delay time difference; and delaying the first synchronization signal according to the first delay amount and delaying the second synchronization signal according to the second delay amount.

With this method, desynchronization between the first synchronization signal to be given to the first radar and the second synchronization signal to be given to the second radar is reduced. With this method, position estimation accuracy in the subsequent processor can be improved.
(7) In the method for synchronizing a plurality of radars according to (6) above, the setting includes: smoothing a high-frequency component of a value obtained by multiplying the delay time difference by a predetermined gain using a loop filter; and setting the first delay amount and the second delay amount corresponding to an output of the loop filter.
(8) In the method for synchronizing a plurality of radars according to (6) or (7) above, the method derives frequencies of the first IF signal and the second IF signal using an annihilating filter (AF) method.

With this configuration, the processing speed can be significantly improved compared to a mode in which FFT processing is executed on a cycle of a synchronization signal.
(9) A vehicle includes the multistatic radar system according to any of (1) to (5) above.

The present disclosure can achieve a multistatic radar system, a vehicle, and a method for synchronizing a plurality of radars that can improve position estimation accuracy.

What is claimed is:

1. A multistatic radar system, comprising:
at least two radars including a first radar configured to operate on a cycle of a first synchronization signal, transmit a transmission wave, and acquire a first intermediate frequency (IF) signal based on the transmission wave and a first reflected wave of the transmission wave from a target;
a second radar configured to operate on a cycle of a second synchronization signal, receive a second reflected wave of the transmission wave from the target, and acquire a second IF signal based on the second reflected wave; and
processing circuitry configured to compensate for desynchronization between the first synchronization signal and the second synchronization signal.

2. The multistatic radar system according to claim 1, wherein the processing circuitry is configured to:
calculate a delay time difference between the first synchronization signal and the second synchronization signal based on a difference value between a frequency of the first IF signal and a frequency of the second IF signal;
set a first delay amount and a second delay amount corresponding to the delay time difference;
delay the first synchronization signal according to the first delay amount; and
delay the second synchronization signal according to the second delay amount.

3. The multistatic radar system according to claim 2, wherein the processing circuitry includes:
a loop filter configured to smooth a high-frequency component of a value obtained by multiplying the delay time difference by a predetermined gain;
a first lookup table in which the first delay amount corresponding to an output of the loop filter is set; and
a second lookup table in which the second delay amount corresponding to the output of the loop filter is set.

4. The multistatic radar system according to claim 3, wherein
the first lookup table maps delay amounts to delay values for the first synchronization signal,
the second lookup table maps delay amounts to delay values for the second synchronization signal, and
the first and second lookup tables are configured to produce asymmetric delay adjustments that collectively minimize the delay time difference between the first synchronization signal and the second synchronization signal.

5. The multistatic radar system according to claim 2, wherein the processing circuitry is further configured to estimate a distance and angle to a target based on the first IF signal and the second IF signal.

6. The multistatic radar system according to claim 5, wherein the processing circuitry is further configured to stop processing when the delay time difference exceeds a predetermined value.

7. The multistatic radar system according to claim 2, wherein the processing circuitry is configured to derive the frequency of the first IF signal and the frequency of the second IF signal by applying an annihilating filter (AF) method to discrete time-series data samples of the first and second IF signals.

8. The multistatic radar system according to claim 2, wherein the processing circuitry is further configured to inhibit downstream spatial position estimation when an absolute value of the calculated delay time difference exceeds a predetermined threshold value.

9. The multistatic radar system of claim 1, wherein the processing circuitry is configured to determine the frequency of the first IF signal and the frequency of the second IF signal by applying an annihilating filter process to discrete time-series data samples of the first and second IF signals.

10. The multistatic radar system of claim 1, wherein the first radar and the second radar are configured as frequency-modulated continuous-wave (FMCW) radars mounted at spaced-apart positions on an vehicle platform.

11. The multistatic radar system according to claim 1, wherein the first radar is further configured to receive the second reflected wave of a second transmission wave transmitted by the second radar, and the first IF signal further includes a component based on the second reflected wave.

12. The multistatic radar system according to claim 1, further comprising three or more radars, wherein the processing circuitry is configured to reduce desynchronization among synchronization signals of each of the three or more radars.

13. A vehicle comprising:
a vehicle body; and
the multistatic radar system according to claim 1, the multistatic radar system being mounted to the vehicle body.

14. A method for synchronizing a plurality of radars in a multistatic radar system, the method comprising:
operating a first radar on a cycle of a first synchronization signal to transmit a transmission wave and acquire a first IF signal based on the transmission wave and a first reflected wave of the transmission wave from a target;
operating a second radar on a cycle of a second synchronization signal to receive a second reflected wave of the transmission wave from the target, and acquire a second IF signal based on the second reflected wave;
calculating a delay time difference between the first synchronization signal and the second synchronization signal based on a frequency difference value between a frequency of the first IF signal and a frequency of the second IF signal;
setting a first delay amount and a second delay amount corresponding to the calculated delay time difference;
delaying delivery of the first synchronization signal to the first radar according to the first delay amount; and
delaying delivery of the second synchronization signal to the second radar according to the second delay amount.

15. The method for synchronizing a plurality of radars according to claim 14, wherein setting the first delay amount and the second delay among includes:
multiplying the calculated delay time difference by a predetermined feedback loop gain value to generate a scaled error signal;
smoothing a high-frequency component of the scaled error signal using a loop filter; and
setting the first delay amount and the second delay amount corresponding to an output of the loop filter.

16. The method for synchronizing a plurality of radars according to claim 15, further comprising:
querying a first lookup table using the output of the loop filter to extract the first delay amount; and
querying a second lookup table using the output of the loop filter to extract the second delay amount.

17. The method for synchronizing a plurality of radars according to claim 14, further comprising deriving frequencies of the first IF signal and the second IF signal using an annihilating filter (AF) method.

18. The method for synchronizing a plurality of radars according to claim 17, further comprising:
calculating a predetermined threshold value based on a maximum allowable target distance error and a speed of light;
comparing an absolute value of the calculated delay time difference to the predetermined threshold value; and
in response to the absolute value of the calculated delay time difference exceeding the predetermined threshold value, suspending estimation of a distance and angle to the target based on the first IF signal and the second IF signal.
